(19) United States
(12) Patent Application Publication
(10) Pub. No.: US 2025/0286438 A1
(43) Pub. Date: Sep. 11, 2025

(54) MOTOR COOLING SYSTEM

(71) Applicant: MCF Electric Drive Corporation, Hiroshima City (JP)

(72) Inventors: Naoki ITASAKA, Hiroshima City (JP); Hisayuki KABASHIMA, Hiroshima City (JP)

(21) Appl. No.: 18/967,066

(22) Filed: Dec. 3, 2024

(30) Foreign Application Priority Data
Mar. 5, 2024 (JP) 2024-033423

(51) Int. Cl. H02K 9/19; H02K 1/32; H02K 3/24

(52) U.S. Cl. CPC H02K 9/19; H02K 1/32; H02K 3/24

(57) ABSTRACT

A motor cooling system, comprising a cooling means for cooling an oil, a stator in which a stator coil is mounted, a rotor, and a stator side oil passage and a rotor side oil passage capable of supplying the oil that has passed through the cooling means to the stator and the rotor, respectively; being configured such that at least a portion of the oil that has passed through the stator side oil passage is supplied to the coil end of the stator coil without flowing inside the stator core, and at least a portion of the oil that has passed through the rotor side oil passage is supplied from the radially inner side to at least the coil end without flowing inside the rotor core.

### CROSS-REFERENCE TO RELATED APPLICATIONS

This application is based on Japanese Application No. 2024-33423 filed on Mar. 5, 2024, the contents of which are incorporated herein by reference.

### BACKGROUND OF THE INVENTION

### Field of the Invention

The present invention relates to a motor cooling system, and more particularly to a motor cooling system that supplies an oil for cooling to each part of a motor.

### Background of the Disclosure

As electric vehicles become more widespread, there is a demand for the motors that drive them to be easier to install and more productive, easier to deploy in a wide range of vehicle models, and cheaper to manufacture, and to achieve these goals, there is a demand to reduce the size of the motor while maintaining its output, in other words, to increase the output density of the motor.

In order to increase the output density of a motor, it is unavoidable to increase the density of the current flowing through the stator coil, but increasing the current density in a motor can lead to a decrease in motor output in some cases, because, for example, the stator core, stator coil, rotor core, and (in the case of a synchronous motor) permanent magnets become hot. In particular, the coil ends of the stator coil protruding from both axial ends of the stator core are one of the locations that highly require cooling, as it is difficult for a coolant to reach the coil ends and the coil coating (insulating material) may be melt-damaged if it becomes hot.

Therefore, for example, JP-A No. 2019-146387 discloses a cooling structure for a rotating electric machine comprising a stator cooling means that has a coolant flow path extending in the axial direction above the stator core, and cools the coil by dripping a coolant onto the coil end from a coolant dripping section, which is a hole formed in the coolant flow path; and a cooling means in which a coolant that has been discharged from a discharge hole in an axial flow passage (hollow inside a rotating shaft) through which the coolant flows and has flowed inside the rotor is scattered radially outward by centrifugal force to hit the coil end, thereby cooling the coil.

However, in the above-mentioned JP-A No. 2019-146387, the coolant that has flowed inside the rotor, in other words, the coolant that has been heated to a certain extent by cooling the inside of the rotor, is allowed to hit to the coil end, hence, depending on the operating conditions, the coil end may not be sufficiently cooled, thus in this respect, there is room for improvement in the JP-A No. 2019-146387.

The present invention has been made in consideration of the above-mentioned points, and an object of the present invention is to provide a motor cooling system capable of efficiently cooling the coil ends of a stator coil.

### SUMMARY

In order to achieve the above object, the motor cooling system according to the present invention is configured to supply a low-temperature oil, which has not been used for cooling the stator core or rotor core, to the coil end from multiple directions simultaneously.

Specifically, the present invention is directed to a motor cooling system that supplies an oil for cooling to each part of a motor.

This motor cooling system is characterized in that the system comprises: a cooling means for cooling an oil, a stator having a cylindrical stator core to which a stator coil is mounted, a rotor having a cylindrical rotor core disposed inside the stator core, a stator side oil passage capable of supplying the oil that has passed through the cooling means to the stator, and a rotor side oil passage capable of supplying the oil that has passed through the cooling means to the rotor; and the stator is configured such that at least a portion of the oil that has passed through the stator side oil passage is supplied to at least a coil end on one side in an axial direction of the stator coil without flowing through the stator core, and the rotor is configured such that at least a portion of the oil that has passed through the rotor side oil passage is supplied from the radially inner side to at least the coil end on one side in the axial direction without flowing inside the rotor core.

According to this configuration, of the oil that has passed through the cooling means, in other words, that is maintained at a relatively low temperature (for convenience, also referred to as “fresh oil”), at least a portion of the oil that has passed through the stator side oil passage is supplied to at least the coil end on one side in the axial direction (hereinafter simply referred to as “one side”) without flowing inside the stator core, so that the fresh oil can cool, for example, the radial outside of the coil end, the center of the coil end in the radial direction, or the like.

Furthermore, of the fresh oil, at least a portion of the oil that has passed through the rotor side oil passage is supplied to at least the coil end on one side without flowing inside the rotor core, so that the coil end can be cooled from the radially inner side (hereinafter simply referred to as the “inside”) by the fresh oil.

In this way, the fresh oil that has not been used to cool the stator core or rotor core is supplied to the coil end from multiple directions simultaneously, thereby making it possible to efficiently cool the coil end.

In addition, in the above motor cooling system, it may be permissible that the stator is configured such that a portion of the oil that has passed through the stator side oil passage is supplied to the coil end on one side in the axial direction, and at least a portion of remaining oil is supplied in the axial direction into the stator core, and the rotor is configured such that a portion of the oil that has passed through the rotor side oil passage is supplied to the coil end on one side in the axial direction, and the remaining oil is supplied in the axial direction into the rotor core.

With this configuration, a portion of the oil that has passed through the stator side oil passage is supplied to the coil end on one side, and at least a portion of the remaining oil is supplied in the axial direction into the stator core, thereby making it possible to cool also the inside of the stator core with a fresh oil while maintaining a state in which the coil end on one side is cooled by the fresh oil.

Furthermore, a portion of the oil that has passed through the rotor side oil passage is supplied to the coil end on one side, and the remaining oil is supplied in the axial direction into the rotor core, thereby making it possible to cool also the inside of the stator core with a fresh oil while maintaining a state in which the coil end on one side is cooled from inside by the fresh oil.

In this way, a fresh oil is not only supplied to the coil end on one side, but also simultaneously supplied into the stator core and the rotor core, thereby efficiently cooling each part of the motor, including the coil ends.

Furthermore, in the above motor cooling system, it may be permissible that the stator is configured such that a portion of the remaining oil that has passed through the stator side oil passage is supplied into the stator core, and another portion of the remaining oil is supplied to the coil end on an other side in the axial direction without flowing through the stator core, and the rotor is configured such that the oil supplied into the rotor core reaches the end on the other side in the axial direction of the rotor core, and then is supplied from the radially inner side to the coil end on the other side in the axial direction.

With this configuration, another portion of the remaining oil that has passed through the stator side oil passage is supplied to the coil end on the other side in the axial direction (hereinafter simply referred to as the “other side”), so that the coil end on the other side can also be cooled by a fresh oil.

Furthermore, since the oil supplied into the rotor core is supplied from the inside to the coil end on the other side, it is possible to cool not only the coil end on one side but also the coil end on the other side with the oil from the inside, though the oil is used after cooling the inside of the rotor core.

In this way, a fresh oil is not only supplied to the coil end on one side, into the stator core, and into the rotor core simultaneously, but the oil is also supplied to the coil end on the other side, allowing each part of the motor, including the coil end on one side, to be cooled more efficiently over a wider area.

In addition, in the above motor cooling system, it may be permissible that the stator is configured such that the oil that has passed through the stator side oil passage passes through an annular space formed concentrically with the stator core in an oil plate attached to the end on one side in the axial direction of the stator core, and is distributed to the coil end on one side in the axial direction and into the stator core, and the rotor is configured such that the oil that has passed through the rotor side oil passage passes through an annular space formed concentrically with the rotor core in an end plate attached to the end on one side in the axial direction of the rotor core, and is distributed to the coil end on one side in the axial direction and into the rotor core.

With this configuration, by utilizing an oil plate attached to the end on one side in the axial direction of the stator core and an end plate attached to the end on one side in the axial direction of the rotor core, it is possible to easily realize a configuration in which the coil ends are cooled by a fresh oil without flowing inside the stator core or rotor core.

Furthermore, a fresh oil supplied axially into the stator core and rotor core first passes through the annular space formed in the oil plate and end plate, and then is distributed into the stator core and rotor core, making it possible to evenly supply a fresh oil to, for example, oil passages formed in the stator core and oil passages formed in the rotor core.

In this way, a fresh oil is not only supplied to the coil end on one side, but is also supplied evenly into the stator core and rotor core, making it possible to more efficiently cool each part of the motor, including the coil ends.

Furthermore, in the above motor cooling system, it may be permissible that the rotor core has a plurality of axially extending magnet holes formed into which permanent magnets are embedded, the stator is configured such that the oil supplied into the stator core flows in the axial direction through a space between a slot formed in the stator core and the stator coil inserted into the slot, and the rotor is configured such that the oil supplied into the rotor core flows in the axial direction through the magnet holes.

With this configuration, an oil flows axially inside the stator core though a space between the slot and the stator coil, and also flows axially inside the rotor core through the magnet holes in which the permanent magnets are embedded, so that the stator coil and permanent magnets can be directly cooled by the fresh oil. Therefore, it is possible to more reliably and efficiently cool each part of the motor, including the coil end.

### Advantageous Effect of the Invention

As described above, according to the motor cooling system of the present invention, the coil ends of the stator coil can be efficiently cooled.

### BRIEF DESCRIPTION OF THE DRAWINGS

FIG. 1 is a vertical cross-sectional view schematically showing a main part of a motor cooling system according to a first embodiment of the present invention.

FIG. 2 is a block view schematically illustrating an example of a cooling system in an electric vehicle.

FIG. 3 A is a perspective view schematically showing an entire stator.

FIG. 3B is an enlarged perspective view schematically showing a first coil end.

FIG. 4A is a perspective view schematically showing the upper part of a first oil plate.

FIG. 4B is a sectional arrow view taken along the line b-b in FIG. 4A.

FIG. 4C is a perspective view showing the flow of an oil in the stator.

FIG. 5 is a perspective view schematically showing a rotor.

FIG. 6A is a perspective view schematically showing an oil introduction passage of a rotor shaft.

FIG. 6B is a perspective view showing the oil passage formed in the first end plate.

FIG. 6C is a perspective view showing the flow of an oil in the entire rotor.

FIG. 7 is a vertical cross-sectional view schematically illustrating a motor cooling system according to a modified example of the first embodiment.

FIG. 8 is a vertical cross-sectional view schematically illustrating a motor cooling system according to a second embodiment of the present invention.

FIG. 9A is a cross-sectional view looking at the surface on the output axis side of a first oil plate.

FIG. 9B is a cross-sectional view of the rotor core.

FIG. 9C is a cross-sectional view of the rotor core.

FIG. 9D is a perspective view showing the flow of an oil in a stator.

FIG. 10A is a perspective view schematically showing an oil passage formed in a rotor.

FIG. 10B is a perspective view showing a space formed in a first end plate.

FIG. 10C is a view explaining the space formed in the first end plate.

FIG. 11A is a cross-sectional view schematically showing an oil passage in a rotor core.

FIG. 11B is a perspective view schematically showing the flow of an oil in an entire rotor.

FIG. 12 is a vertical cross-sectional view schematically illustrating a motor cooling system according to a third embodiment of the present invention.

FIG. 13 A is a cross-sectional view schematically showing the surface of an oil plate facing a stator core.

FIG. 13B is a perspective view schematically showing a second end plate.

FIG. 14A is a perspective view schematically illustrating the flow of an oil in a stator from the first oil plate to the anti-output axis side.

FIG. 14B is a perspective view schematically illustrating the flow of an oil in a stator from the first oil plate to the output axis side.

FIG. 14C is a perspective view schematically illustrating the flow of an oil in a stator from the second oil plate to the output axis side.

FIG. 14D is a perspective view schematically illustrating the flow of an oil in a stator from the second oil plate to the anti-output axis side.

FIG. 15A is a perspective view schematically showing an oil passage formed in a rotor.

FIG. 15B is a perspective view schematically showing the flow of an oil in a rotor.

FIG. 16 is a perspective view schematically showing a rotor core according to another embodiment of the present invention.

### DETAILED DESCRIPTION

Hereinafter, embodiments of the present invention will be described with reference to the drawings. In each drawing, the symbol AC indicates the axis center of a synchronous motor, the symbol OS indicates the output axis side (the other side in the axial direction (the direction in which the axis center AC extends)), and the symbol AOS indicates the anti-output axis side (one side in the axial direction).

### Embodiment 1

### —Motor Cooling System Overview—

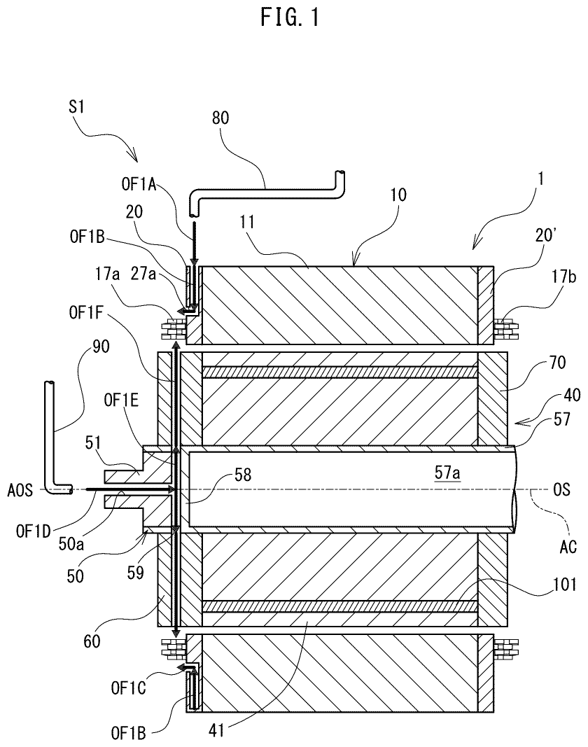

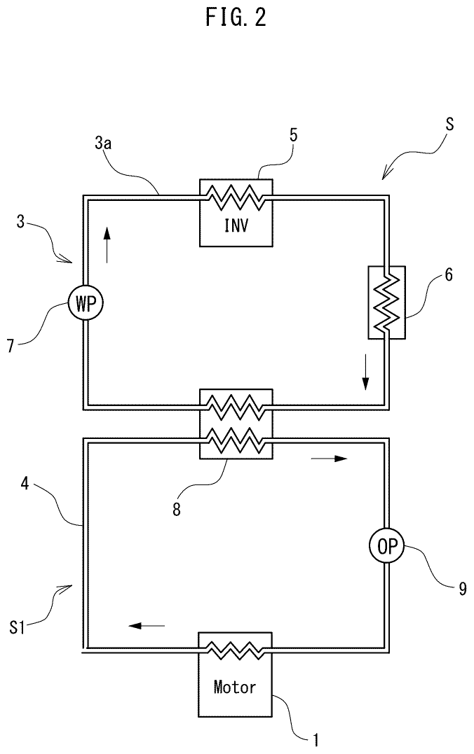

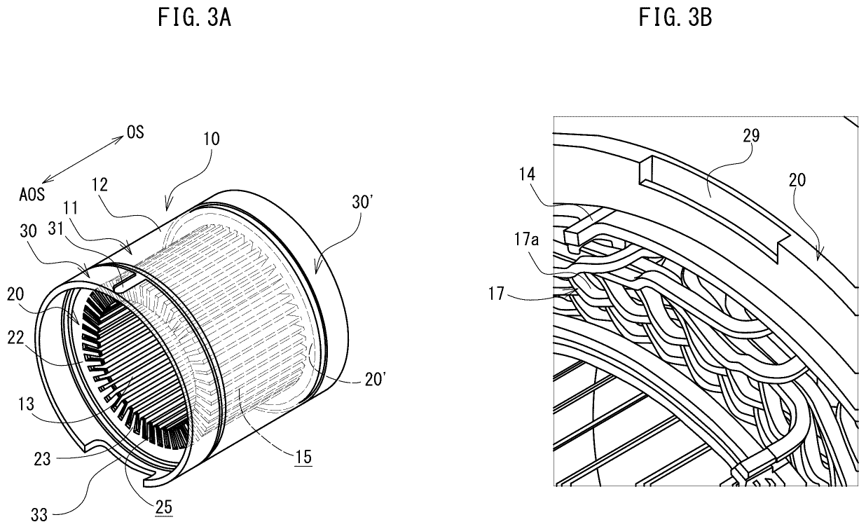

FIG. 1 is a vertical cross-sectional view schematically showing a main part of a motor cooling system S1 according to the present embodiment. FIG. 2 is a block view schematically showing an example of a cooling system S in an electric vehicle. The motor cooling system S1 constitutes a part of the cooling system S in an electric vehicle shown in FIG. 2, and as shown in FIG. 1, supplies an oil for cooling to a first coil end (each part of the motor 1) 17a of a stator coil 17 (see FIG. 3A and FIG. 3B). The motor cooling system S1 includes a heat exchanger (cooling means) 8 for cooling an oil, a motor 1 having a stator 10 and a rotor 40, a stator side oil passage 80 capable of supplying the oil that has passed through the heat exchanger 8 to the stator 10, and a rotor side oil passage 90 capable of supplying the oil that has passed through the heat exchanger 8 to the rotor 40.

### —Cooling System—

As shown in FIG. 2, the cooling system S includes an inverter cooling system 3 and a motor cooling system S1, and a heat exchanger 8 is interposed between the inverter cooling system 3 and the motor cooling system S1.

The inverter cooling system 3 has a circulation path 3a through which the cooling water circulates, and an inverter 5, a radiator 6, and a water pump 7 for circulating the cooling water, each of which is provided on the circulation path 3a. In the inverter cooling system 3, heat generated by the inverter 5 is absorbed by the cooling water, and the heat absorbed by the cooling water is dissipated to the outside by the radiator 6, thereby maintaining the cooling water and the inverter 5 at low temperatures.

On the other hand, the motor cooling system SI has a circulation path 4 through which an oil circulates, a motor 1, and an oil pump 9 that pumps an oil to the motor 1, each of which is provided on the circulation path 4. In this motor cooling system S1, heat generated in the motor 1 is absorbed by the oil, and the oil that has absorbed the heat accumulates at the bottom of a motor housing (not shown) and then returns to the circulation path 4. In this motor cooling system S1, the heat absorbed by the oil is absorbed by the cooling water through indirect heat exchange between the circulation paths 3a and 4 in the heat exchanger 8, and then the heat is radiated to the outside by the radiator 6, thereby maintaining the oil at a relatively low temperature.

In the present embodiment, by using the cooling system S configured as described above, an oil (also referred to as “fresh oil” for convenience) maintained at a relatively low temperature is sent at an appropriate proportion through the stator side oil passage 80 to the stator 10 side and through the rotor side oil passage 90 to the rotor 40 side.

### —Stator—

FIG. 3A is a perspective view schematically showing the entire stator 10. FIG. 3B is an enlarged perspective view schematically showing the first coil end 17a. Note that in FIG. 3A, the stator coil 17 is omitted from the illustration in order to make the drawing easier to see. As shown in FIG. 3A and FIG. 3B, the stator 10 includes a cylindrical stator core 11, a stator coil 17 attached to the stator core 11, first and second oil plates 20, 20′, and first and second oil guides 30, 30′.

### <Stator Core>

The stator core 11 is formed, for example, by stacking a plurality of electromagnetic steel plates in the axial direction, and has a cylindrical yoke 12 and a plurality of teeth 13 arranged in the circumferential direction at intervals, each of which protrudes radially inward from the inner peripheral surface of the yoke 12, as shown in FIG. 3A. In this manner, the plurality of teeth 13 are arranged in the circumferential direction at intervals, as a result, a plurality of slots 15 that open radially inward that are defined (prescribed) by adjacent teeth 13 are formed in the stator core 11.

### <Oil Plate>

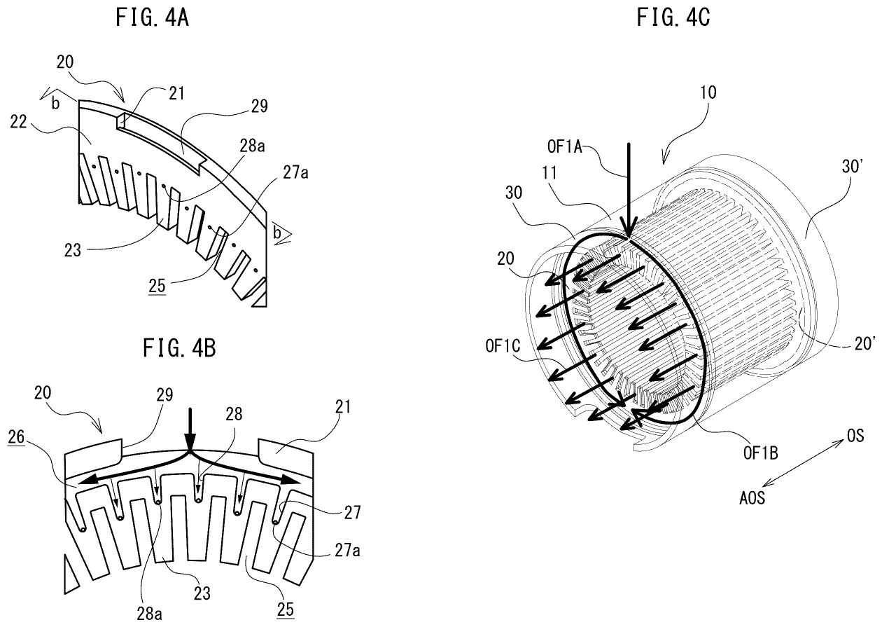

FIG. 4A is a perspective view schematically showing the upper part of the first oil plate 20. FIG. 4B is a sectional arrow view taken along the line b-b in FIG. 4A. FIG. 4C is a perspective view showing the flow of an oil in the stator 10. The first oil plate 20 on the anti-output axis side AOS in the axial direction (hereinafter also simply referred to as the “anti-output axis side AOS”) and the second oil plate 20′ on the output axis side OS in the axial direction (hereinafter also simply referred to as the “output axis side OS”) are both made of a non-magnetic material such as resin, are formed in an annular shape, and have the same cross-sectional outer shape as the stator core 11. Specifically, the first oil plate 20 has a portion corresponding to the yoke 12 (for convenience, referred to as the “yoke 22”), a portion corresponding to the teeth 13 (for convenience, referred to as the “teeth 23”), and a portion corresponding to the slots 15 (for convenience, referred to as the “slots 25”). The second oil plate 20′ is also similar, in its cross-sectional outer shape, to that of the first oil plate 20, and therefore a description thereof will be omitted.

The first oil plate 20 is formed, for example, by combining two members in the axial direction, and has a space formed therein, as shown in FIG. 4A and FIG. 4B. More specifically, inside the first oil plate 20, an annular space 26 is formed concentrically with the first oil plate 20, the radially outer side of which is defined by an annular outer wall portion 21. The upper end of the outer wall portion 21 is cut out, and this cut out portion serves as an oil introduction port 29 for introducing oil into the annular space 26.

Moreover, inside the first oil plate 20, a portion that defines the radially inner side of the annular space 26 is recessed radially inward to form a first radial oil passage 27 that extends in the same direction as the teeth 23. At the tip end (the radially inner end) of the first radial oil passage 27, a through hole 27a that opens to the anti-output axis side AOS is formed.

Furthermore, inside the first oil plate 20, a portion defining the radially inner side of the annular space 26 is recessed radially inward to be shallower than the first radial oil passage 27, thereby forming a second radial oil passage 28 extending in the same direction as the teeth 23. At the tip end (the radially inner end) of the second radial oil passage 28, a through hole 28a opening to the anti-output axis side AOS is formed.

The first radial oil passages 27 and the second radial oil passages 28 are formed such that a pair of circumferentially adjacent first radial oil passages 27 and a pair of circumferentially adjacent second radial oil passages 28 are alternately arranged in the circumferential direction. Note that such annular space 26, first radial oil passages 27, and second radial oil passages 28 are not formed inside the second oil plate 20′.

The first oil plate 20 is attached to the end of the stator core 11 on the anti-output axis side AOS so that it is concentric with the stator core 11 and the positions of the teeth 23 in the circumferential direction coincide with the positions of the teeth 13 of the stator core 11. The second oil plate 20′ is also attached to the end of the stator core 11 on the output axis side OS in a manner similar to that of the first oil plate 20.

### <Stator Coil>

The stator coil 17 is composed of a U-shaped coil wire having two parallel legs and a connecting part connecting the two legs, and its surface is covered with an insulating material except for a part. The stator coil 17 is attached (mounted) to the stator core 11 and the first and second oil plates 20, 20′ by inserting the two legs from the anti-output axis side AOS into a pair of adjacent slots 15, 25, for example. Then, the tip of the leg of one stator coil 17 protruding from the slot of the second oil plate 20′ to the output axis side OS, and the tip of the leg of the other stator coil 17 likewise protruding from the slot to the output axis side OS are connected by welding or the like.

A connecting portion of the U-shaped coil wire protruding from the slot 25 of the first oil plate 20 toward the anti-output axis side AOS constitutes a first coil end 17a, as shown in FIG. 3B. Similarly, a portion of the U-shaped coil wire protruding from the slot of the second oil plate 20′ toward the output axis side OS and connected by welding or the like constitutes a second coil end 17b. In this stator 10, current flows from a power source (not shown) via the input terminal 14 to the stator coil 17, and the stator coil 17 is the main heat source in the stator 10.

### <Oil Guide>

The first oil guide 30 on the anti-output axis side AOS and the second oil guide 30′ on the output axis side OS are both made of a non-magnetic material such as resin and are formed in a cylindrical shape. The first and second oil guides 30, 30′ are concentric with the stator core 11 and are interposed between the stator core 11 as well as the first and second oil plates 20, 20′, and the motor housing, in the axial direction. This allows the first and second oil plates 20, 20′ to be pressed into the stator core 11 and firmly attached to the stator core 11.

As shown in FIG. 3A, a recess is formed in the upper end of the first oil guide 30, and this recess serves as an oil guide portion 31 that guides an oil to the oil introduction port 29 of the first oil plate 20. In addition, a notch is formed in the lower end of the first oil guide 30, and this notched portion serves as an oil discharge port 33 for discharging the oil.

### <Oil Flow>

In the stator 10 configured as above, the fresh oil after heat exchange in the heat exchanger 8 is supplied to the stator 10 (more specifically, the oil guide portion 31 of the first oil guide 30) through the stator side oil passage 80, as shown by the thick arrow OF1A in FIG. 1 and FIG. 4C. The fresh oil supplied to the oil guide portion 31 is guided to the oil introduction port 29 of the first oil plate 20, and is supplied from the oil introduction port 29 to the annular space 26, as shown by the thick arrow in FIG. 4B.

The fresh oil supplied to the annular space 26 flows down in the annular space 26 while being branched into the first radial oil passage 27 and the second radial oil passage 28, as shown by the thin arrows in FIG. 4B. As a result, the annular space 26 is filled with a fresh oil, as shown by the thick arrows OF1B in FIG. 1 and FIG. 4C.

The fresh oil filled in the annular space 26 is ejected out from the through hole 27a formed at the tip of the first radial oil passage 27 and the through hole 28a formed at the tip of the second radial oil passage 28 to the anti-output axis side AOS, as shown by the thick arrow OF1C in FIG. 1 and FIG. 4C, and is supplied to the first coil end 17a, for example, from the radial outside or to the radial center, depending on the positions and inclination angles of the through holes 27a, 28a.

In this way, the fresh oil that has passed through the stator side oil passage 80 via the heat exchanger 8 is supplied directly to the first coil end 17a without flowing inside (through) the stator core 11, so that the first coil end 17a is efficiently cooled from the radial outside, the center, etc. by the intact fresh oil.

### —Rotor—

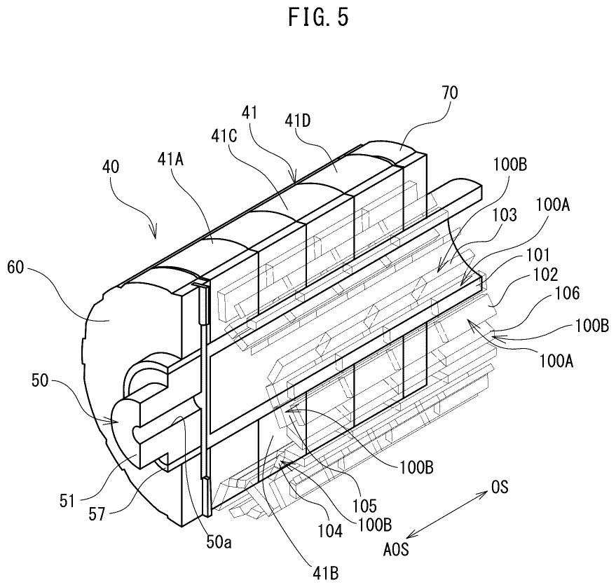

FIG. 5 is a perspective view schematically showing the rotor 40. As shown in

FIG. 1, the rotor 40 is arranged (disposed) inside the stator core 11 so as to be concentric with the stator 10 and to provide a gap (air gap) between the outer circumferential surface and the teeth 13. As shown in FIG. 5, the rotor 40 has a rotor core 41, a rotor shaft 50, permanent magnets 101, 102, 103, 104, 105, and 106 embedded in magnet holes formed in the rotor core 41, and first and second end plates 60 and 70 attached to both ends of the rotor core 41 in the axial direction, respectively.

### <Rotor Core>

The rotor core 41 is a laminated body in which a predetermined number of annular magnetic thin plates formed into a predetermined shape are stacked in the axial direction, and is formed in a cylindrical shape having a central hole to which the rotor shaft 50 is fixed by shrink fitting. Although only four magnetic poles are illustrated in FIG. 5, the rotor core 41 has six magnet holes formed for each magnetic pole extending in the axial direction so that the rotor 40 has eight magnetic poles and the prospect angle o along the circumferential direction of one magnetic pole as viewed from the axis center AC is 45 degrees, and permanent magnets 101, 102, - - - are embedded in the six magnet holes. As shown in FIG. 5, the rotor core 41 is configured as a so-called skewless rotor core in which four laminated bodies 41A, 41B, 41C, 41D, each of which is made of stacked magnetic thin plates, are combined with a skew angle of 0 degrees. As a result, in the present embodiment, the magnet holes and the permanent magnets 101, 102, - - - extend straight from the end of the rotor core 41 on the anti-output axis side AOS to the end of the output axis side OS in the axial direction. The magnetic thin plate may be made of an electromagnetic steel plate, which is a type of silicon steel plate.

Each magnetic pole is composed of a two-layer structure consisting of an outer embedded magnet section 100A including two permanent magnets 101, 102 arranged in a V-shape on the radially outer side, and an inner embedded magnet section 100B including four permanent magnets 103, 104, 105, 106 arranged in a U-shape on the radially inner side.

The outer embedded magnet section 100A has one magnet hole, and the two permanent magnets 101, 102 are inserted into the magnet hole so as to form a V-shape in which the distance between them increases toward the radially outward direction and decreases toward the radially inward direction. The portion of the magnet hole that is not filled with the two permanent magnets 101, 102 remains as a gap (flux barrier) 42.

The inner embedded magnet section 100B has four magnet holes. The permanent magnets 103 and 106 are inserted into the magnet holes so that the distance between them increases toward the radially outward direction and decreases toward the radially inward direction, respectively. The permanent magnets 104 and 105 are inserted into the magnet holes, and the portions of the magnet holes that are not filled with the permanent magnets 104 and 105 remain as gaps 43 and 44.

### <Rotor Shaft>

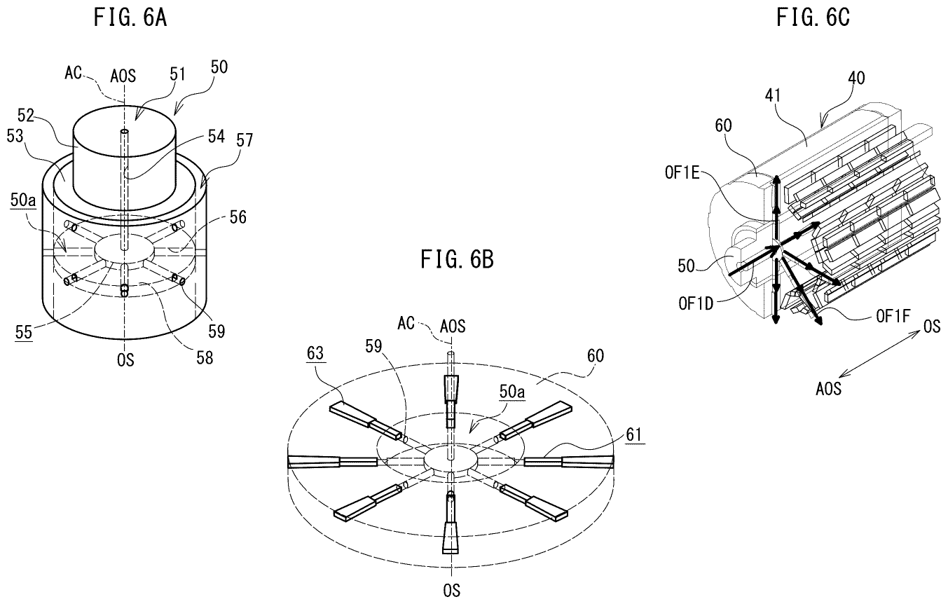

FIG. 6A is a perspective view schematically showing the oil introduction passage 50a of the rotor shaft 50. FIG. 6B is a perspective view showing the oil passage formed in the first end plate 60. FIG. 6C is a perspective view showing the flow of an oil in the entire rotor 40. The rotor shaft 50 has an oil introduction section 51 and a shaft main body 57.

### <Oil Introduction Section>

As shown in FIG. 6A, the oil introduction section 51 is formed in such a shape that a cylindrical small diameter section 52 and a cylindrical large diameter section 53 are connected concentrically in the axial direction via a stepped surface. Through the oil introduction section 51, an oil introduction hole 54 that communicates with the rotor side oil passage 90 and extends in the axial direction is formed. At the end on the output axis side OS of the large diameter section 53, a recess with a circular cross section that communicates with the oil introduction hole 54 is formed. Furthermore, at the end of the output axis side OS of the large diameter section 53, eight oil discharge grooves are formed, which extend radially from the recess to the radial outside at equal intervals of 45 degrees in the circumferential direction. The radially outer end of each oil discharge groove opens at the outer circumferential surface of the large diameter section 53.

### <Shaft Main Body>

As shown in FIG. 6A, the shaft main body 57 is formed in a cylindrical shape centered on the axis center AC. The shaft main body 57 is provided with a partition plate 58 that divides the hollow portion 57a in the axial direction. In addition, the shaft main body 57 has eight oil discharge holes 59 formed that extend radially outward at equal intervals of 45 degrees in the circumferential direction and penetrate the shaft main body 57.

### <Oil Introduction Passage>

The rotor shaft 50 is constructed by fitting the large diameter portion 53 into the hollow portion 57a of the shaft main body 57 so that the circumferential positions of the eight oil discharge grooves and the eight oil discharge holes 59 coincide with each other, and then joining the two by welding or the like. When the oil introduction section 51 and the shaft main body 57 are combined, the recess and the oil discharge groove are covered with the surface on the anti-output axis side AOS of the partition plate 58, and as shown in FIG. 6A, a disk-shaped space 55 and an oil discharge passage 56 are formed, respectively. As a result, the oil introduction passage 50a is formed with which a fresh oil that has flowed through the rotor side oil passage 90 flows through the oil introduction hole 54, then, fills the disk-shaped space 55, and flows from the disk-shaped space 55 through the oil discharge passage 56 to the radially outward direction, and is then sent out radially to the outside of the rotor shaft 50 through the oil discharge hole 59.

### <End Plate>

The first and second end plates 60, 70 are annular aluminum plates and have the same outer shapes as the inner and outer circumferential surfaces of the rotor core 41, respectively. The first end plate 60 is attached to the end on the anti-output axis side AOS of the rotor core 41, and the second end plate 70 is attached to the end on the output axis side OS of the rotor core 41 each by welding or the like. As shown in FIG. 1, the first end plate 60 is disposed so as to overlap the first coil end 17a when viewed in the radial direction. Note that the second end plate 70 does not have any distinctive features, and therefore a detailed description thereof will be omitted.

The first end plate 60 has eight connecting flow passages 61 formed extending radially from its inner peripheral surface to the outside in the radial direction at equal intervals of 45 degrees in the circumferential direction, as shown in FIG. 6B. In addition, the first end plate 60 has eight first diffusion oil passages 63 formed, which communicate with the radially outer end of the connecting flow passage 61 and extend further radially outward of the connecting flow passages 61. Each first diffusion oil passage 63 is formed so that it opens on the outer peripheral surface of the first end plate 60 and the cross-sectional area increases as it goes radially outward. Then, when the rotor shaft 50 and the first end plate 60 are combined so that the eight oil discharge holes 59 and the eight connecting flow passages 61 coincide in the circumferential direction, the oil introduction passage 50a of the rotor shaft 50 and the first diffusion oil passage 63 communicate with each other via the connecting flow passages 61, as shown in FIG. 6B.

The connecting flow passage 61 and the first diffusion oil passage 63 may be formed, for example, by using a sand mold for casting, or may be formed, for example, by constituting the first end plate 60 with two plates (not shown) that are divided into two in the axial direction, and providing grooves or holes that become part of the oil passage on the front and back surfaces of each plate, and combining these grooves or holes in the axial direction.

### <Oil Flow>

In the rotor 40 configured as described above, the fresh oil after heat exchange in the heat exchanger 8 passes through the rotor side oil passage 90, and is supplied to the rotor 40 (more specifically, to the oil introduction hole 54 of the oil introduction section 51), as shown by the thick arrows OF1D in FIG. 1 and FIG. 6C. The fresh oil supplied to the oil introduction hole 54 flows sequentially inside the oil introduction passage 50a, and is sent out radially to the outside of the rotor shaft 50 through the oil discharge holes 59, as shown by the thick arrow OF1E in FIG. 1 and FIG. 6C.

Then, the fresh oil discharged radially from the oil discharge holes 59 flows through the connecting flow passages 61 to the first diffusion oil passage 63, and as shown by the thick arrow OF IF in FIG. 1 and FIG. 6C, is scattered radially outward from the outer circumferential surface of the first end plate 60 by centrifugal force, and is supplied to the first coil end 17a from the radially inner side. At this time, since the first diffusion oil passage 63 is formed so that the cross-sectional area increases as it goes radially outward, it is possible to prevent the first diffusion oil passage 63 from being blocked by an oil.

In this way, the fresh oil that has passed through the rotor side oil passage 90 via the heat exchanger 8 is supplied to the first coil end 17a from the radially inner side without flowing inside the rotor core 41, so that the first coil end 17a is efficiently cooled from the radially inner side by the intact fresh oil.

### —Effect—

As described above, according to the motor cooling system S1 of the present embodiment, a fresh oil that has not been used to cool the stator core 11 or the rotor core 41 is simultaneously supplied to the first coil end 17a from the radial outside, center, inside, etc., so that the first coil end 17a can be efficiently cooled.

Furthermore, by utilizing the first oil plate 20 attached to the end of the stator core 11 and the first end plate 60 attached to the end of the rotor core 41, a configuration can be easily realized in which the first coil end 17a is cooled by a fresh oil without flowing inside the stator core 11 or the rotor core 41.

### (Modification)

This modified example differs from the first embodiment in that not only the first coil ends 17a but also the second coil ends 17b are cooled. The following description will focus on the differences from the first embodiment.

### —Cooling System—

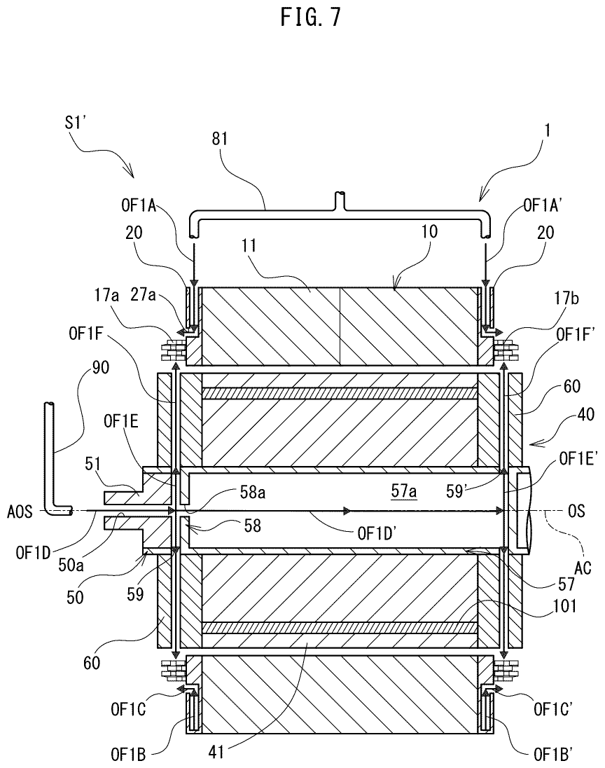

FIG. 7 is a vertical cross-sectional view schematically showing a motor cooling system S1′ according to this modified example. In this motor cooling system S1′, a fresh oil after heat exchange in the heat exchanger 8 passes through a stator side oil passage 81 and is supplied not only to the end on the anti-output axis side AOS of the stator 10 but also to the end on the output axis side OS of the stator 10, as shown in FIG. 7.

### —Stator—

In the stator 10 according to this modification, a plate identical to the first oil plate 20 (second oil plate 20), instead of a second oil plate 20′, is attached to the end on the output axis side OS of the stator core 11, as shown in FIG. 7. Specifically, the first and second oil plates 20 are attached to both ends of the stator core 11 in the axial direction so as to be symmetrical with respect to the stator core 11.

### <Oil Flow>

In the stator 10 configured as above, a fresh oil is supplied to the first and second oil plates 20 through the stator side oil passage 81, as shown by the thick arrows OF1A and OF1A′ in FIG. 7. Then, the fresh oil is filled into the annular space 26, as shown by the thick arrows OF1B and OF1B′ in FIG. 7, and then ejected from the first oil plate 20 to the anti-output axis side AOS, as shown by the thick arrow OF1C in FIG. 7, and ejected from the second oil plate 20 to the output axis side OS, as shown by the thick arrow OF1C′ in FIG. 7, to be supplied to the first and second coil ends 17a, 17b.

In this way, the fresh oil that has passed through the stator side oil passage 81 is supplied directly to not only the first coil end 17a but also the second coil end 17b without flowing inside the stator core 11, so that the first and second coil ends 17a, 17b are efficiently cooled from the radial outside, center, etc. by the intact fresh oil.

### —Rotor—

In the rotor 40 according to this modification, a second end plate 60 identical to the first end plate 60, instead of a second end plate 70, is attached to the end on the output axis side OS of the rotor core 41, as shown in FIG. 7. Specifically, the first and second end plates 60 are attached to both axial ends of the rotor core 41 so as to be symmetrical with respect to the rotor core 41. The second end plate 60 on the output axis side OS is disposed so as to overlap the second coil end 17b when viewed in the radial direction.

Further, a partition plate 58 that axially divides the hollow portion 57a of the shaft main body 57 has a through hole 58a formed that axially penetrates the partition plate 58. Furthermore, in the shaft main body 57, eight oil discharge holes 59′ that extend radially outward at equal intervals of 45 degrees in the circumferential direction and penetrate the shaft main body 57 are formed in a portion in the axial direction that corresponds to the second end plate 60.

### <Oil Flow>

In the rotor 40 configured as described above, a fresh oil is supplied to the oil introduction hole 54 of the oil introduction section 51 through the rotor side oil passage 90, as shown by the thick arrow OF1D in FIG. 7. The fresh oil supplied to the oil introduction hole 54 is, as shown by the thick arrow OF1E in FIG. 7, sent out radially to the outside of the rotor shaft 50 through the oil discharge hole 59 on the anti-output axis side AOS, and flows through the through-hole 58a, and as shown by the thick arrow OF1D′ in FIG. 7, flows through the hollow portion 57a of the shaft main body 57 toward the output axis side OS.

The fresh oil that has flowed through the hollow portion 57a of the shaft main body 57 toward the output axis side OS is, as shown by the thick arrows OF1E′ in FIG. 7, sent out radially to the outside of rotor shaft 50 through the oil discharge hole 59′ on the output axis side OS. The fresh oil that has been sent out radially from the oil discharge holes 59, 59′ on the anti-output axis side AOS and the output axis side OS flows, as shown by the thick arrows OF1F and OF1F′ in FIG. 7, into the first diffusion oil passage 63 via the connecting flow passage 61, and is scattered radially outward from the outer circumferential surface of the first and second end plates 60 by centrifugal force, and is supplied from the radially inner side to the first and second coil ends 17a, 17b. In this way, the fresh oil that has passed through the rotor side oil passage 90 is supplied from the radially inner side not only to the first coil end 17a but also to the second coil end 17b without flowing inside the rotor core 41, so that the first and second coil ends 17a, 17b are efficiently cooled from the radially inner side by the intact fresh oil.

### —Effect—

As described above, according to the motor cooling system S1′ of this modified example, a fresh oil that has not been used to cool the stator core 11 or the rotor core 41 is supplied simultaneously to the first and second coil ends 17a, 17b, thereby efficiently cooling the first and second coil ends 17a, 17b.

### Embodiment 2

This embodiment differs from the first embodiment described above in that not only the first coil end 17a, but also the stator core 11 and the rotor core 41 are cooled. The following description will focus on the differences from the first embodiment.

### —Stator—

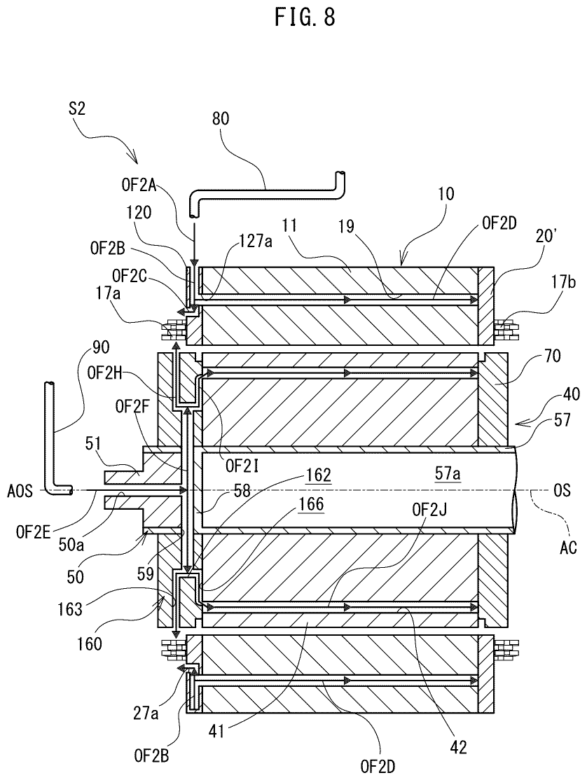

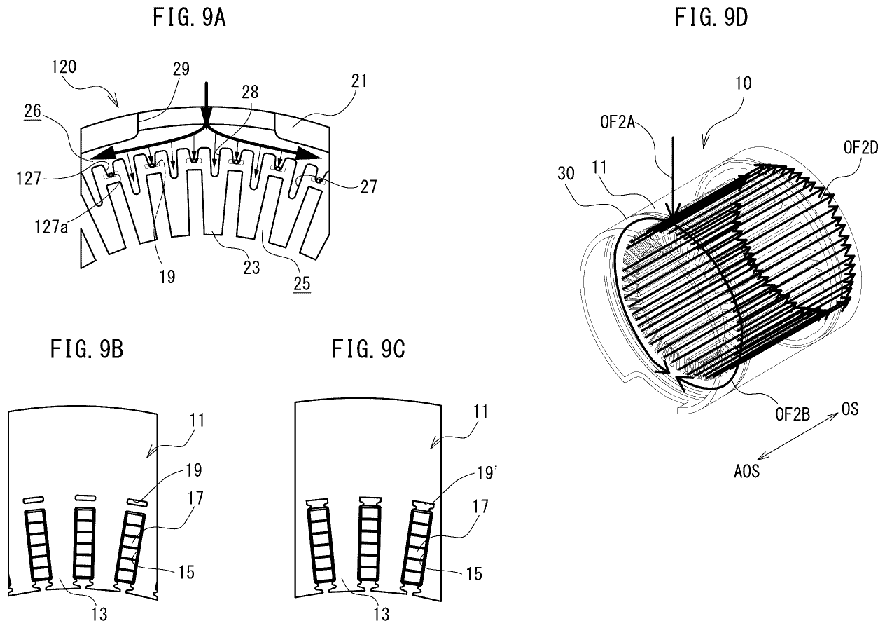

FIG. 8 is a vertical cross-sectional view schematically showing a motor cooling system S2 according to the present embodiment. FIG. 9A is a cross-sectional view looking at the surface on the output axis side OS of the first oil plate 120. FIG. 9B and FIG. 9C are cross-sectional views of the rotor core 41, respectively. FIG. 9D is a perspective view showing the flow of an oil in the stator 10.

### <Oil Plate>

Inside the first oil plate 120, a third radial oil passage 127 extending in the same direction as the slot 25 is formed by recessing a portion that defines the radially inner side of the annular space 26 radially inward, in addition to the first radial oil passage 27 and the second radial oil passage 28, as shown in FIG. 9A. The third radial oil passages 127 are formed so that the number of the third radial oil passages 127 corresponds to the number of the slots 25 and are aligned in the circumferential direction. A through hole 127a that opens to the output axis side OS is formed at the tip end (the radially inner end) of the third radial oil passage 127. Note that on the surface on the anti-output axis side AOS of the first oil plate 120, through holes 27a, 28a are formed at the tip ends of the first and second radial oil passages 27, 28, respectively, as in the first embodiment.

The first oil plate 120 is attached to the end on the anti-output axis side AOS of the stator core 11 so as to be concentric with the stator core 11 and so that the positions of the teeth 23 in the circumferential direction coincide with the positions of the teeth 13 of the stator core 11. When the first oil plate 120 is attached to the stator core 11 in this manner, the axial oil passage 19 (19′) formed in the stator core 11 communicates with the through hole 127a, as shown in FIG. 9A.

### <Stator Core>

In the stator core 11, an axial oil passage 19 penetrating the stator core 11 over the entire axial length is formed on the radial outside of each slot 15, as shown in FIG. 9B. Instead of separately forming such axial oil passage 19, a space between the slot 15 and the stator coil 17 inserted into the slot 15 may be used as the axial oil passage 19′, as shown in FIG. 9C.

### <Oil Flow>

In the stator 10 configured as above, a fresh oil is, as shown by the thick arrow OF2A in FIG. 8 and FIG. 9D, supplied to the stator 10 (more specifically, to the oil guide portion 31 of the first oil guide 30) through the stator side oil passage 80. The fresh oil supplied to the oil guide portion 31 is guided to the oil introduction port 29 of the first oil plate 120, and is, as shown by the thick arrow in FIG. 9A, supplied from the oil introduction port 29 to the annular space 26.

As shown by the thin arrows in FIG. 9A, the fresh oil supplied to the annular space 26 flows down in the annular space 26 while being divided (distributed) into the first radial oil passage 27, the second radial oil passage 28, and the third radial oil passage 127. As a result, the annular space 26 is filled with a fresh oil, as shown by the thick arrows OF2B in FIG. 8 and FIG. 9D.

A portion of the fresh oil filled in the annular space 26 is ejected from the through hole 27a formed at the tip of the first radial oil passage 27 and the through hole 28a formed at the tip of the second radial oil passage 28 to the anti-output axis side AOS, as shown by the thick arrow OF2C in FIG. 8, and is supplied to the first coil end 17a, as in the first embodiment.

On the other hand, the remaining portion of the fresh oil filled in the annular space 26 is ejected out to the output axis side OS from the through hole 127a formed at the tip of the third radial oil passage 127, and flows, through the axial oil passage 19 (19′) that penetrates the stator core 11, to the output axis side OS, as shown by the thick arrow OF2D in FIG. 8 and FIG. 9D.

In this way, a portion of the fresh oil that has passed through the stator side oil passage 80 is supplied to the first coil end 17a, and the remaining portion of the fresh oil is supplied in the axial direction into the stator core 11, so that the inside of the stator core 11 is cooled by the intact fresh oil while maintaining a state in which the first coil end 17a in a cooled.

In addition, the oil that has flowed through the axial oil passage 19 (19′) and reached the end on the output axis side OS of the stator core 11 may advantageously be discharged to the outside of the stator core 11 through a discharge hole (not shown), for example, formed in the second oil plate 20′

### —Rotor—

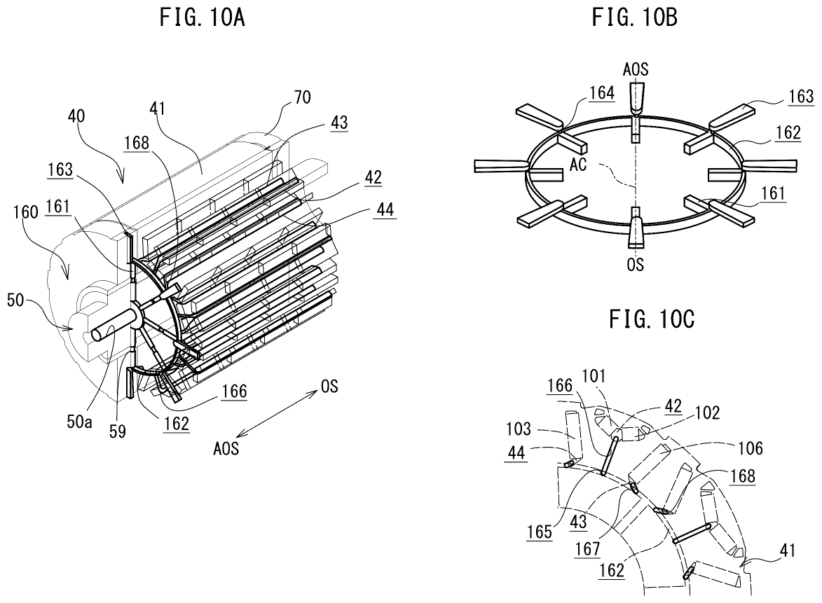

FIG. 10A is a perspective view schematically showing an oil passage formed in the rotor 40. FIG. 10B is a perspective view showing a space formed in the first end plate 160. FIG. 10C is a view explaining the space formed in the first end plate 160. Note that in FIG. 10C, the permanent magnets 104 and 105 are omitted in order to make the drawing easier to see. In addition, in the rotor 40 of the present embodiment, the rotor shaft 50, the rotor core 41, and the second end plate 70 have the same configuration as those in the first embodiment.

### <End Plate>

As shown in FIG. 8, the first end plate 160 is disposed so as to overlap the first coil end 17a when viewed in the radial direction, similarly to the first end plate 60. As shown in FIG. 10A and FIG. 10B, inside the first end plate 160, a chamber space 162 having an annular shape when viewed in the axial direction is formed concentrically with the axis center AC. In addition, inside the first end plate 160, eight connecting flow passages 161 are also formed, which extend radially outward from the inner peripheral surface of the first end plate 160 at equal intervals of 45 degrees in the circumferential direction and connect (communicate) with the chamber space 162. The first end plate 160 is combined with the rotor shaft 50 so that the eight oil discharge holes 59 and the eight connecting flow passages 161 coincide in the circumferential direction.

Furthermore, in the first end plate 160, eight first diffusion oil passages 163 extending radially are formed on the anti-output axis side AOS of the chamber space 162. Like the first diffusion oil passage 63, each first diffusion oil passage 163 opens at the outer circumferential surface of the first end plate 160 and is formed so that the cross-sectional area increases as it goes radially outward, however, unlike the first diffusion oil passage 63, the radially inner end communicates with the chamber space 162 via a communication hole 164, as shown in FIG. 10B.

The connecting flow path 161, the chamber space 162 and the first diffusion oil path 163 may be formed, for example, by using a sand mold for casting, or may be formed, for example, by constituting the first end plate 160 with three plates (not shown) divided into three in the axial direction, providing grooves and holes that become part of the oil path, etc. on the front and back surfaces of each plate, and combining these grooves and holes in the axial direction.

A plurality of grooves are formed on the surface on the output axis side OS of the first end plate 160, and when, as shown in FIG. 8, the surface on the output axis side OS of the first end plate 160 is attached to the end surface on the anti-output axis side AOS of the rotor core 41 by welding or the like, the grooves are covered with the end surface on the anti-output axis side AOS of the rotor core 41, and, as shown in FIG. 10C, eight first radial oil passages 166 extending radially are formed on the output axis side OS of the chamber space 162. The radially inner end of each of the first radial oil passages 166 communicates with the chamber space 162 via a communication hole 165. The length of each of the first radial oil passages 166 is set so that the radially outer end communicates with the gap 42 of the magnet hole (the portion of the magnet hole not filled with the permanent magnets 101, 102).

Similarly, the grooves are covered with the end face on the anti-output axis side AOS of the rotor core 41, and sixteen rows of second radial oil passages 168 are also formed, which extend at an incline in the circumferential direction as they move radially outward, on the output axis side OS of the chamber space 162. The radially inner end of each second radial oil passage 168 communicates with the chamber space 162 via a communication hole 167. The length and inclination direction of the second radial oil passage 168 are set so that the radially outer end communicates with the gaps 43, 44 of the magnet hole.

The first end plate 160 constructed as described above is attached by welding or the like to the end face on the anti-output axis side AOS of the rotor core 41 so that the radially outer end of the first radial oil passage 166 and the gap 42 of the magnet hole coincide circumferentially, as shown in FIG. 10C.

### <Oil Flow>

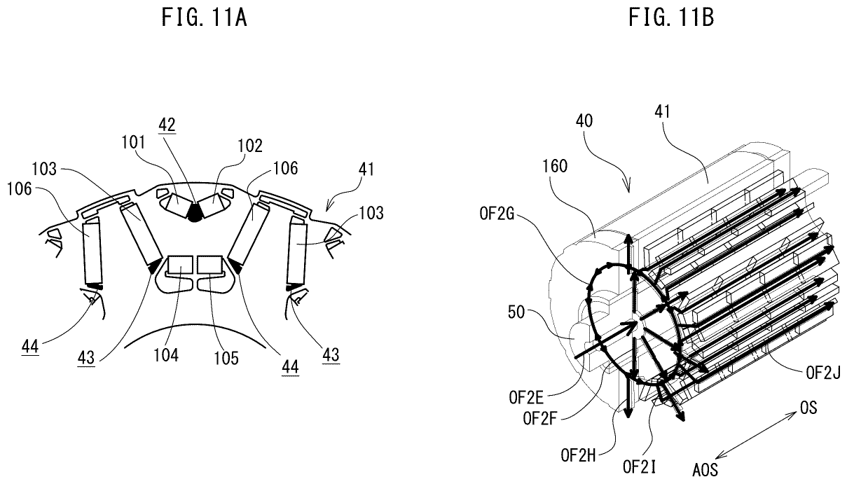

FIG. 11A is a cross-sectional view schematically showing the oil passages in the rotor core 41. FIG. 11B is a perspective view schematically showing the flow of an oil in the entire rotor 40. Note that in FIG. 11A, in order to make the drawing easier to see, hatching that indicates a cross section is omitted, and the oil is shown by the blackened portions.

In the rotor 40 configured as described above, a fresh oil is supplied to the oil introduction hole 54 of the oil introduction section 51 through the rotor side oil passage 90, as shown by the thick arrows OF2E in FIG. 8 and FIG. 11B. The fresh oil introduced into the oil introduction hole 54 flows sequentially through the oil introduction passage 50a, is sent out radially to the outside of the rotor shaft 50 through the oil discharge holes 59, as shown by the thick arrows OF2F in FIG. 8 and FIG. 11B. The fresh oil sent out to the outside of the rotor shaft 50 in this manner reaches the chamber space 162 through the connecting flow passage 161, and fills the chamber space 162, as shown by the thick arrows OF2G in FIG. 11B.

The fresh oil filled in the chamber space 162 is distributed to the first coil end 17a side and the rotor core 41 side. Specifically, as shown by the thick arrow OF2H in FIG. 8 and FIG. 11B, some of the fresh oil filled in the chamber space 162 flows from the chamber space 162 to the first diffusion oil passage 163 via the communication hole 164, and is scattered radially outward from the outer circumferential surface of the first end plate 160 by centrifugal force, and is supplied to the first coil end 17a from the radially inner side.

On the other hand, the remaining portion of the fresh oil filled in the chamber space 162 flows from the chamber space 162 through the communication holes 165, 167 to the first radial oil passage 166 and the second radial oil passage 168, as shown by the thick arrow OF2I in FIG. 8 and FIG. 11B. The fresh oil that has passed through the first radial oil passage 166 flows into the gap 42, as shown in FIG. 11A, and the fresh oil that has passed through the second radial oil passage 168 flows into the gaps 43, 44. The fresh oil that has flowed into the gaps 42, 43, 44 then flows inside the rotor core 41 from the anti-output axis side AOS to the output axis side OS, as shown by the thick arrow OF2J in FIG. 8 and FIG. 11B.

In this way, a portion of the oil that has passed through the rotor side oil passage 90 is supplied to the first coil end 17a, and the remaining oil is supplied in the axial direction into the rotor core 41, so that the inside of the rotor core 41 is cooled by the fresh oil while maintaining a state in which the first coil end 17a is cooled from the radially inside.

In addition, the oil that flows through the gaps 42, 43, 44 and reaches the end on the output axis side OS of the rotor core 41 may advantageously be discharged to the outside of the rotor core 41 through a discharge hole (not shown), for example, formed in the second end plate 70.

### —Effect—

As described above, according to the motor cooling system S2 of the present embodiment, a fresh oil is not only supplied to the first coil end 17a, but also simultaneously supplied to the stator core 11 and the rotor core 41, thereby efficiently cooling each part of the motor 1, including the first coil end 17a.

Furthermore, a fresh oil supplied axially into the stator core 11 and the rotor core 41 first passes through the annular space 26 formed in the first oil plate 120 and the annular chamber space 162 formed in the first end plate 160 before being distributed into the stator core 11 and the rotor core 41, therefore, this makes it possible to evenly supply the fresh oil to, for example, the axial oil passage 19 (19′) formed in the stator core 11 and the gaps 42, 43, 44 formed in the rotor core 41.

In particular, in the rotor 40, the first diffusion oil passage 163 is formed so that its cross-sectional area increases as it moves radially outward, thereby making it possible to prevent the first diffusion oil passage 163 from being blocked by oil, and this makes it possible to prevent negative pressure from being generated in the first diffusion oil passage 163, which would otherwise impair the uniformity of the oil in the chamber space 162.

Furthermore, by adopting an axial oil passage 19′ in which oil flows axially within the stator core 11 through between the slots 15 and the stator coil 17, the stator coil 17 can be directly cooled, and since the oil flows axially within the rotor core 41 through the gaps 42, 43, 44 of the magnet holes in which the permanent magnets 101, 102, 103, 106 are embedded, the permanent magnets 101, 102, - - - can be directly cooled by a fresh oil.

In addition, as described above, since the rotor core 41 is so-called skewless, the flow resistance to the oil flowing through the gaps 42, 43, 44 can be reduced, thereby making it possible to cool the permanent magnets 101, 102, - - - even more efficiently.

### Embodiment 3

This embodiment differs from the first and second embodiments in that the second coil ends 17b are cooled. The following description will focus on the differences from the first and second embodiments.

### —Cooling System—

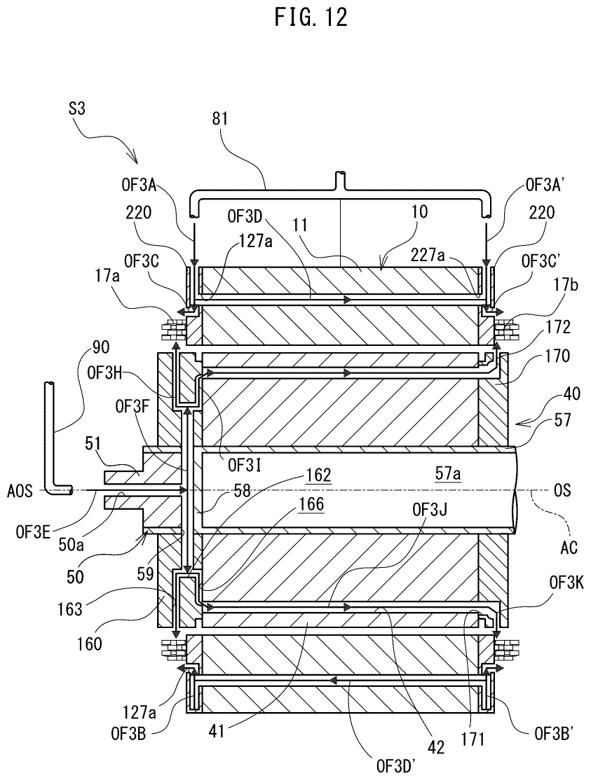

FIG. 12 is a vertical cross-sectional view schematically showing a motor cooling system S3 according to the present embodiment. In this motor cooling system S3, a fresh oil is supplied to the ends on the anti-output axis side AOS and the output axis side OS of the stator 10 through a stator side oil passage 81, as shown in FIG. 12.

### —Stator—

In the stator 10 of the present embodiment, the stator core 11 has the same configuration as that of the second embodiment.

### <Oil Plate>

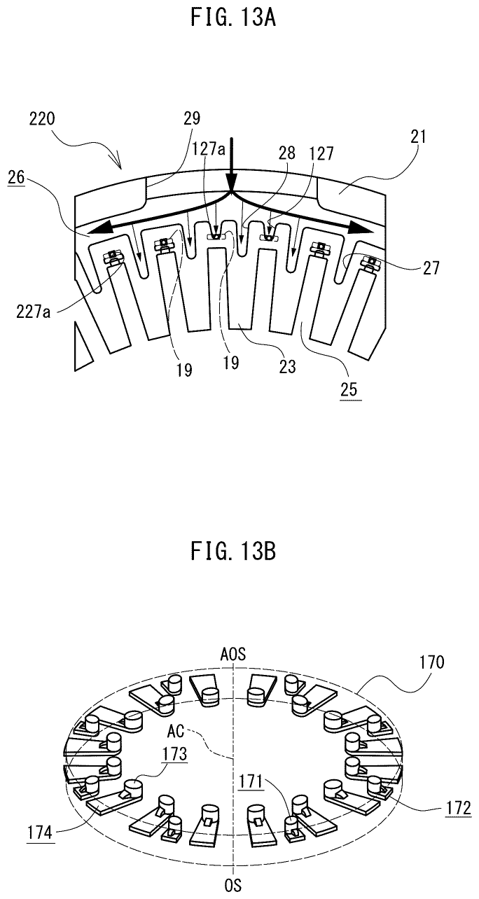

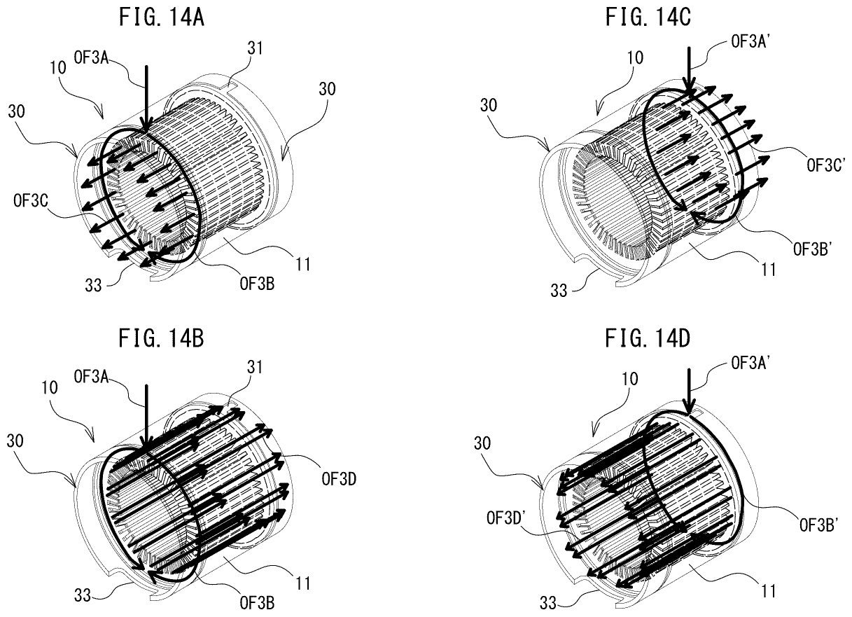

FIG. 13 A is a cross-sectional view schematically showing the surface of the oil plate 220 facing the stator core 11. FIG. 13B is a perspective view schematically showing the second end plate 170. In the present embodiment, the same oil guides 30 are attached to both ends on the anti-output axis side AOS and the output axis side OS of the stator core 11 so as to be symmetrical across the stator core 11 (see FIG. 14A, FIG. 14B, FIG. 14C and FIG. 14D).

In the present embodiment, substantially the same oil plates 220 are attached to both ends on the anti-output axis side AOS and the output axis side OS of the stator core 11, as shown in FIG. 12. The only difference between the first oil plate 220 on the anti-output axis side AOS and the second oil plate 220 on the output axis side OS is that the position of the through hole 127a and the position of the through hole 227a are staggered in the circumferential direction, therefore, the first oil plate 220 on the anti-output axis side AOS will be described as a representative example, below.

Inside the first oil plate 220, the first radial oil passage 27, the second radial oil passage 28, and the third radial oil passage 127 are formed, similarly to the first oil plate 120 of the second embodiment, however, the number of the third radial oil passages 127 is half the number of the third radial oil passages 127 in the first oil plate 120. More specifically, in the first oil plate 220, a pair of slots 25 adjacent to each other in the circumferential direction and having the third radial oil passage 127 formed on the radial outer side, and a pair of slots 25 adjacent to each other in the circumferential direction and not having the third radial oil passage 127 formed on the radial outer side are formed so as to be alternately arranged in the circumferential direction.

Thus, a through hole 227a penetrating the first oil plate 220 is formed on the radial outer side of a pair of slots 25 on which the third radial oil passage 127 is not formed on the radial outer side. Since the through hole 227a does not communicate with the annular space 26, a fresh oil supplied from the oil introduction port 29 of the first oil plate 220 to the annular space 26 does not pass through the through hole 227a. Note that on the surface on the anti-output axis side AOS of the oil plate 120, the through holes 27a, 28a are formed at the tip portions of the first and second radial oil passages 27, 28, respectively, like in the first and second embodiments.

The first oil plate 220 is attached to the end on the anti-output axis side AOS of the stator core 11 so as to be concentric with the stator core 11 and so that the positions of the teeth 23 in the circumferential direction coincide with the positions of the teeth 13 of the stator core 11. When the first oil plate 220 is attached to the stator core 11 in this manner, the axial oil passage 19 (19′) formed in the stator core 11 communicates not only with the through hole 127a but also with the through hole 227a.

### <Oil Flow>

FIG. 14A is a perspective view schematically illustrating the flow of an oil in the stator 10 from the first oil plate 220 to the anti-output axis side AOS. FIG. 14B is a perspective view schematically illustrating the flow of an oil in the stator 10 from the first oil plate 220 to the output axis side OS. FIG. 14C is a perspective view schematically illustrating the flow of an oil in the stator 10 from the second oil plate 220 to the output axis side OS. FIG. 14D is a perspective view schematically illustrating the flow of an oil in the stator 10 from the second oil plate 220 to the anti-output axis side AOS.

In the stator 10 configured as above, the fresh oil that has passed through the stator side oil passage 81 is supplied to the oil guide portion 31 of the first oil guide 30, as shown by the thick arrow OF3A in FIG. 12 and FIG. 14A and FIG. 14B. At this time, also on the output axis side OS, the fresh oil that has passed through the stator side oil passage 81 is supplied to the oil guide portion 31 of the second oil guide 30, as shown by the thick arrow OF3A′ in FIG. 12 and FIG. 14C and FIG. 14D.

The fresh oil supplied to the oil guide portion 31 is guided to the oil introduction port 29 of the first and second oil plates 220, and is supplied from the oil introduction port 29 to the annular space 26, as shown by the thick arrows in FIG. 13A. The fresh oil supplied to the annular space 26 flows down in the annular space 26 while being diverted (distributed) to the first radial oil passage 27, the second radial oil passage 28, and the third radial oil passage 127, as shown by the thin arrows in FIG. 13A. As a result, the annular space 26 in the first and second oil plates 220 is filled with a fresh oil, as shown by the thick arrows OF3B in FIG. 12 and FIG. 14A and FIG. 14B and the thick arrows OF3B′ in FIG. 12 and FIG. 14C and FIG. 14D.

In the first oil plate 220, a portion of the fresh oil filled in the annular space 26 is ejected from the through holes 27a formed at the tip of the first radial oil passage 27 and the through holes 28a formed at the tip of the second radial oil passage 28 to the anti-output axis side AOS, as shown by the thick arrows OF3C in FIG. 12 and FIG. 14A, and is supplied to the first coil end 17a. At this time, also in the second oil plate 220, a portion of the fresh oil filled in the annular space 26 is ejected from the through holes 27a, 28a to the output axis side OS, as shown by the thick arrows OF3C′ in FIG. 12 and FIG. 14C, and is supplied to the second coil end 17b.

In the first oil plate 220, the remaining portion of the fresh oil filled in the annular space 26 is ejected from the through hole 127a formed at the tip of the third radial oil passage 127 to the output axis side OS, and flows toward the output axis side OS through the axial oil passage 19 (19′) penetrating the stator core 11, as shown by the thick arrow OF3D in FIG. 12 and FIG. 14B. At this time, also in the second oil plate 220, the remaining portion of the fresh oil filled in the annular space 26 is ejected from the through hole 127a formed at the tip of the third radial oil passage 127 to the anti-output axis side AOS, and flows toward the anti-output axis side AOS through the axial oil passage 19 (19′) penetrating the stator core 11, as shown by the thick arrow OF3D′ in FIG. 12 and FIG. 14D.

In the first oil plate 220, the oil that has flowed through the axial oil passage 19 (19′) toward the anti-output axis side AOS passes through the through hole 227a and is supplied to the first coil end 17a, as shown by the thick arrow OF3D′ in FIG. 12 and

FIG. 14D. At this time, also in the second oil plate 220, the oil that has flowed through the axial oil passage 19 (19′) toward the output axis side OS passes through the through hole 227a and is supplied to the second coil end 17b, as shown by the thick arrow OF3D in FIG. 12 and FIG. 14B.

In this way, a portion of the fresh oil that has passed through the stator side oil passage 81 is supplied to the first and second coil ends 17a, 17b, and the remaining portion of the fresh oil is supplied in the axial direction into the stator core 11, so that the first and second coil ends 17a, 17b are efficiently cooled and the inside of the stator core 11 is efficiently cooled by the fresh oil.

The oil supplied to the first and second coil ends 17a, 17b is discharged from the oil discharge ports 33 of the first and second oil guides 30 to the outside of the stator 10 (to the bottom of the motor housing).

### —Rotor—

In the rotor 40 of the present embodiment, the rotor shaft 50, the first end plate 160, and the rotor core 41 have the same configuration as those in the second embodiment.

### <End Plate>

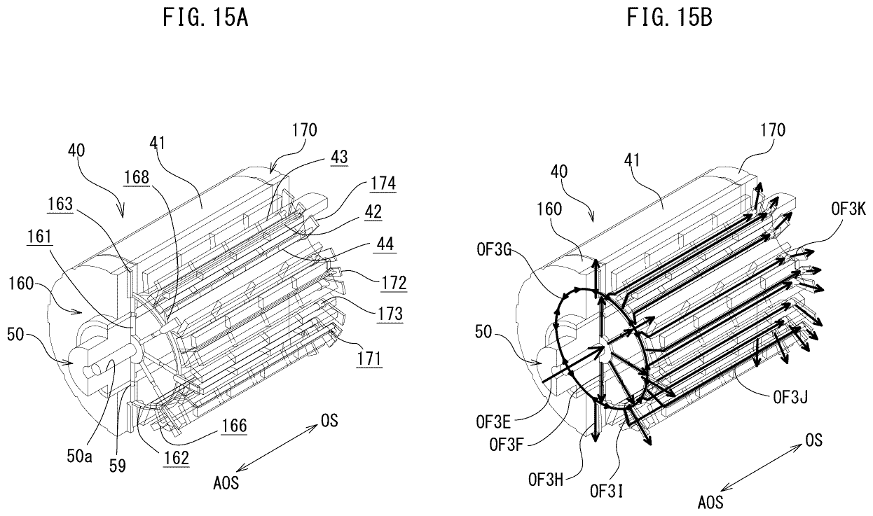

FIG. 15A is a perspective view schematically showing the oil passage formed in the rotor 40. FIG. 15B is a perspective view schematically showing the flow of an oil in the rotor 40.

As shown in FIG. 13B, the second end plate 170 has eight outer holes 171 with a circular cross section, formed by recessing the surface on the anti-output axis side AOS of the second end plate 170 toward the output axis side OS at equal intervals of 45 degrees in the circumferential direction. The radial positions of these outer holes 171 correspond to the eight gaps 42, respectively. In addition, the second end plate 170 has sixteen inner holes 173, which are larger in diameter than the outer holes 171, formed by recessing the surface on the anti-output axis side AOS of the second end plate 170 toward the output axis side OS, radially inward of the outer holes 171. The radial positions of these inner holes 173 correspond to the sixteen gaps 43, 44, respectively.

Furthermore, as shown in FIG. 13B, eight second short diffusion oil passages 172 extending in the radial direction are formed in the second end plate 170. Each second short diffusion oil passage 172 is formed so that the radially inner end communicates with the outer hole 171, the passage opens on the outer peripheral surface of the second end plate 170, and the cross-sectional area increases as it moves radially outward. Similarly, sixteen rows of second long diffusion oil passages 174 extending in the radial direction are formed in the second end plate 170. Each second long diffusion oil passage 174 is formed so that the radially inner end communicates with the inner hole 173, the passage opens on the outer peripheral surface of the second end plate 170, and the cross-sectional area increases as it moves radially outward, similar to the second short diffusion oil passage 172.

When the surface on the anti-output axis side AOS of the second end plate 170 is attached by welding or the like to the end face on the output axis side OS of the rotor core 41 so that the outer hole 171 and the gap 42 (the inner hole 173 and the gaps 43, 44) are aligned in the circumferential direction, the second short diffusion oil passage 172 and the gap 42 communicate via the outer hole 171, and the second long diffusion oil passage 174 and the gaps 43, 44 communicate via the inner hole 173, as shown in FIG. 15A.

The outer hole 171, the second short diffusion oil passage 172, the inner hole 173 and the second long diffusion oil passage 174 may be formed, for example, by using a sand mold for casting, or may be formed, for example, by constituting the second end plate 170 with two plates (not shown) that are divided into two in the axial direction, providing grooves or holes that become part of the oil passage on the front and back surfaces of each plate, and combining these grooves or holes in the axial direction.

### <Oil Flow>

In the rotor 40 configured as described above, the flow of an oil from the rotor side oil passage 90 to the end on the output axis side OS of the rotor core 41, specifically, the flow of an oil to the thick arrows OF3E, OF3F, OF3G, OF3H, OF3I, and OF3J in FIG. 12 and FIG. 15B is the same as the flow of an oil to the thick arrows OF2E to OF2J in FIG. 8 and FIG. 11B, so a description thereof will be omitted.

The oil that flows through the gaps 42, 43, 44 and reaches the end on the output axis side OS of the rotor core 41 reaches the second short diffusion oil passage 172 and the second long diffusion oil passage 174 via the outer hole 171 and the inner hole 173, respectively, as shown by the thick arrow OF3K in FIG. 12 and FIG. 15B, and is scattered radially outward from the outer circumferential surface of the second end plate 170 by centrifugal force through the second short diffusion oil passage 172 and the second long diffusion oil passage 174, and is supplied from the radially inner side to the second coil end 17b.

### —Effect—

As described above, according to the motor cooling system S3 of the present embodiment, the fresh oil that has passed through the stator side oil passage 81 is supplied to the second coil end 17b, so that the second coil end 17b can also be cooled by the fresh oil.

Furthermore, since the oil supplied into the rotor core 41 is supplied to the second coil ends 17b from the radially inner side, not only the first coil ends 17a but also the second coil ends 17b can be cooled from the radially inner side. Unlike the first coil ends 17a, the second coil ends 17b are supplied with the oil (which has been heated to a certain degree) after cooling the rotor core 41, etc., but since the number (24) of the second short diffusion oil passages 172 and the second long diffusion oil passages 174 is set to be greater than the number (8) of the first diffusion oil passages 163, in other words, the amount of oil supplied to the second coil ends 17b is relatively greater, so that the second coil ends 17b can also be efficiently cooled.

In this way, a fresh oil is not only supplied to the first coil end 17a, the stator core 11, and the rotor core 41 simultaneously, but oil is also supplied to the second coil end 17b, so that each part of the motor 1, including the first coil end 17a, can be cooled more efficiently over a wider area.

### Other Embodiments

The present invention is not limited to the embodiments, and can be embodied in various other forms without departing from the spirit or main characteristics thereof.

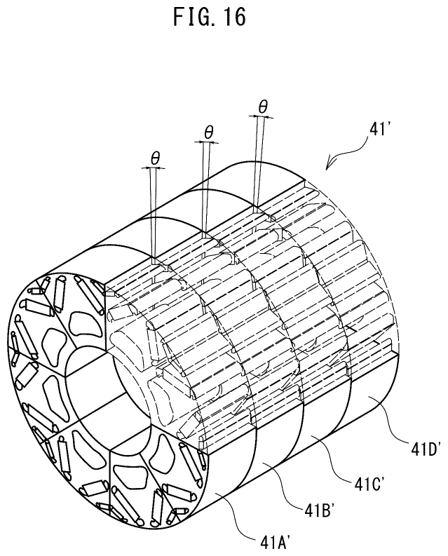

In each of the above embodiments, the rotor core 41 is so-called skewless, however, this is not limiting, and for example, the present invention may be applied to a rotor core 41′ having a skew angle 0, which is formed by combining four laminates 41A′, 41B′, 41C′, and 41D′, each of which is made by stacking a predetermined number of thin magnetic plates in the axial direction, with each laminate being shifted by an angle 0, as shown in FIG. 16.

In addition, in each of the above embodiments, the through holes 27a, 28a extending straight in the axial direction are exemplified, however, this is not limiting, and for example, the through holes may be formed so that they extend at an inclination radially inward as they move axially outward.

Furthermore, in the above embodiment 1, the present invention is applied to a synchronous motor in which permanent magnets 101, 102, - - - are embedded in the rotor core 41, however, this is not limiting, and the present invention may be applied to an asynchronous motor in which permanent magnets are not embedded in the rotor core.

In addition, in the second and third embodiments, the permanent magnets 101, 102, 103, and 106 are targeted for cooling, however, this is not limiting, and the number of radial oil paths may be increased so that the permanent magnets 104 and 105 are also cooled.

As such, the above-described embodiment is merely illustrative in all respects and should not be construed as limiting. Furthermore, all modifications and variations within the scope of the claims are within the scope of the present invention.

Although the present disclosure has been described based on the embodiment, it is understood that the present disclosure is not limited to the embodiments or structures. The present disclosure also includes various modification examples and modifications within the equivalent range. In addition, various combinations and forms, and other combinations and forms including only one element, more than one element, or less than one element, are also within the scope and concept of the present disclosure.

### INDUSTRIAL APPLICABILITY

According to the present invention, the coil ends of the stator coil can be efficiently cooled, therefore, the present invention is extremely useful when applied to a motor cooling system that supplies a cooling oil to each part of a motor.

What is claimed is:

1. A motor cooling system that supplies an oil for cooling to each part of a motor, characterized in that the system comprises:
a cooling means for cooling an oil,
a stator having a cylindrical stator core on which a stator coil is mounted,
a rotor having a cylindrical rotor core disposed inside the stator core,
a stator side oil passage capable of supplying the oil that has passed through the cooling means to the stator, and
a rotor side oil passage capable of supplying the oil that has passed through the cooling means to the rotor;
and
the stator is configured such that at least a portion of the oil that has passed through the stator side oil passage is supplied to at least a coil end on one side in an axial direction of the stator coil without flowing inside the stator core, and
the rotor is configured such that at least a portion of the oil that has passed through the rotor side oil passage is supplied from radially inner side to at least the coil end on one side in the axial direction without flowing inside the rotor core.

2. The motor cooling system according to claim 1, characterized in that:
the stator is configured such that a portion of the oil that has passed through the stator side oil passage is supplied to the coil end on one side in the axial direction, and at least a portion of remaining oil is supplied in the axial direction into the stator core, and the rotor is configured such that a portion of the oil that has passed through the rotor side oil passage is supplied to the coil end on one side in the axial direction, and the remaining oil is supplied in the axial direction into the rotor core.

3. The motor cooling system according to claim 2, characterized in that:
the stator is configured such that a portion of the remaining oil that has passed through the stator side oil passage is supplied into the stator core, and another portion of the remaining oil is supplied to the coil end on an other side in the axial direction without flowing through the stator core, and
the rotor is configured such that the oil supplied into the rotor core reaches the end on the other side in the axial direction of the rotor core and then is supplied from the radially inner side to the coil end on the other side in the axial direction.

4. The motor cooling system according to claim 2, characterized in that:
the stator is configured such that the oil that has passed through the stator side oil passage passes through an annular space formed concentrically with the stator core in an oil plate attached to the end on one side in the axial direction of the stator core, and is distributed to the coil end on one side in the axial direction and into the stator core, and
the rotor is configured such that the oil that has passed through the rotor side oil passage passes through an annular space formed concentrically with the rotor core in an end plate attached to the end on one side in the axial direction of the rotor core, and is distributed to the coil end on one side in the axial direction and into the rotor core.

5. The motor cooling system according to claim 2, characterized in that:
the rotor core has a plurality of axially extending magnet holes formed into which permanent magnets are embedded,
the stator is configured such that the oil supplied into the stator core flows in the axial direction through a space between a slot formed in the stator core and the stator coil inserted into the slot, and
the rotor is configured such that the oil supplied into the rotor core flows in the axial direction through the magnet holes.
